(19) United States
(12) Patent Application Publication
(10) Pub. No.: US 2023/0022070 A1
(43) Pub. Date: Jan. 26, 2023

(54) System, Device, and Method of Detecting Business Email Fraud and Corporate Email Fraud

(71) Applicant: BioCatch Ltd., Tel Aviv (IL)

(72) Inventors: Alexander Basil Zaloum, Boston, MA (US); Alesis Novik, London (GB); Avi Turgeman, New York, NY (US)

(21) Appl. No.: 17/381,277

(22) Filed: Jul. 21, 2021

(51) Int. Cl. H04L 29/08; G06N 20/00; G06F 3/0488; G06Q 20/40; H04L 29/06

(52) U.S. Cl. CPC H04L 67/22; G06N 20/00; G06F 3/04883; G06Q 20/407; G06Q 20/401; H04L 63/1483

(57) ABSTRACT

System, device, and method of detecting business email fraud and corporate email fraud. A method includes: receiving a user request to perform an online transaction on behalf of a corporate entity; generating a notification that requires the user to indicate whether he obtained managerial authorization for performing that online transaction on behalf of that corporate entity; monitoring user gestures and user interactions in response to that notification; receiving a positive answer from the user; performing an analysis of user gestures and user interactions, and generating a signal indicating a determination that the positive answer from the user is false, based on analyzed metrics that correspond to characteristics of the user gestures and user interactions; blocking or unauthorizing, at least temporarily, that online transaction that was requested on behalf of that corporate entity.

### FIELD

Some embodiments are related to the field of computerized systems.

### BACKGROUND

Millions of people utilize mobile and non-mobile electronic devices, such as smartphones, tablets, laptop computers and desktop computers, in order to perform various activities. Such activities may include, for example, browsing the Internet, sending and receiving electronic mail (email) messages, taking photographs and videos, engaging in a video conference or a chat session, playing games, or the like.

### SUMMARY

Some embodiments include devices, systems, and methods of detecting, preventing, handling and/or mitigating fraud and fraudulent transactions; and particularly, fraudulent events or attacks or cyber-attacks that utilize or exploit a corporate email or a business email of a victim, and attempt to transfer funds or to perform fraudulent banking transactions based on such exploit.

For example, a method includes: receiving a user request to perform an online transaction on behalf of a corporate entity; generating a notification that requires the user to indicate whether he obtained managerial authorization for performing that online transaction on behalf of that corporate entity; monitoring user gestures and user interactions in response to that notification; receiving a positive answer from the user; performing an analysis of user gestures and user interactions, and generating a determination that the positive answer from the user is false, based on analyzed metrics that correspond to characteristics of the user gestures and user interactions; blocking or unauthorizing, at least temporarily, that online transaction that was requested on behalf of that corporate entity.

Some embodiments may provide other and/or additional benefits or advantages.

### BRIEF DESCRIPTION OF THE DRAWINGS

FIG. 1 is a schematic block-diagram illustration of a system, in accordance with some demonstrative embodiments of the present invention.

### DETAILED DESCRIPTION OF SOME DEMONSTRATIVE EMBODIMENTS

The Applicants have realized that some cyber-attacks, attacks, and fraud events exploit a fake email message (or a fake other type of communication), that is incoming from an attacker or a “fraudster” but appears to originate from an authorized or a legitimate first party, and is sent (via email, or via other communication means) to a second party; and which induce or command or persuade the message recipient (the second party) to perform a transaction, that he (the second party) believes to be authorized and legitimate, but is in fact fraudulent or illegitimate.

In a first example, Victim Victor is the Chief Financial Officer (CFO) of Company Corp; and Manager Monica is the Chief Executive Officer (CEO) of Company Corp. Attacker Adam sends an email message to Victim Victor. The email message is sent and/or routed by Attacker Adam by utilizing an email spoofing mechanism; such that the email message that Victim Victor receives appears to be incoming from Manager Monica. For example, a fake header or a spoofed header or a manipulated header of the email message that Victim Victor receives (at this business email account, “Victor@CompanyCorp.com”), shows spoofed header data as if the email message was sent from “Monica@CompanyCorp.com”. The content of the email instructs Victim Victor, to immediately wire $4,000 to a particular third party (Robert Recipient), alleging that Robert Recipient must receive immediately payment or else a great damage would occur to Company Corp. Optionally, the spoofed email may also indicate, allegedly on behalf of Manager Monica, that she is currently unavailable for 12 hours as she is now boarding an international flight for an urgent meeting, and therefore she cannot be accessed by phone or by email, and her email instructions must be performed immediately. Based on such email message, which appears to be legitimately incoming from the business email address of Manager Monica, the CFO, Victim Victor, logs-in into the online interface of the bank account of Company Corp, and initiates an urgent or same-day wire transfer of $4,000 to Robert Recipient, based on recipient details that were also included in the spoofed email message. However, the receiving bank account of Robert Recipient, to which the funds are wired, is actually a bank account controlled by Attacker Adam or by another fraudster who conspired together with Attacker Adam to fraudulently obtain money from Company Corp.

The Applicants have realized that some conventional banking systems may attempt, often unsuccessfully, to mitigate this type of attack. For example, the banking interface may present to Victim Victor an on-screen question, such as, “Did you confirm with your Manager, by talking to her face-to-face or over the phone, that this wire transfer is indeed authorized?”; and may allow the user, Victim Victor, to answer “yes” or “no”; and if he answers “no”, then the banking interface may block or freeze or deny the requested transaction, and may inform Victim Victor that according to bank policy and/or according to corporate policy (of Company Corp), he (Victim Victor) must obtain face-to-face or telephonic authorization from his Manager before the transaction can proceed. However, realized the Applicants, such conventional system does not suffice. In some situations, realized the Applicants, Victim Victor may respond with “yes” to the above question, even though he did not in fact verify (face-to-face or telephonically) with Manager Monica the authenticity of the incoming email message. The Applicants have realized that this may occur in various situations or due to various reasons; for example, Victim Victor already believes that Manager Monica is unavailable for 12 hours, as the spoofed email message told him; and her email appears to be legitimate and authentic; and Victim Victor is honestly concerned that delaying the transaction for 12 hours would indeed cause irreparable damage to Company Corp, and/or may result in a personal negative consequence for Victim Victor for not immediately obeying a direct command that was incoming from his Manager.

In a second example, Attacker Alice calls Victim Victor on the phone. Attacker Alice utilizes a telephone number spoofing mechanism, such that the “Caller ID” data that Victim Victor shows on his phone, indicates that the caller is “Manager Monica”, and further indicates the genuine telephone number (corporate or personal) of Manager Monica. In that phone conversation, Attacker Alice has a voice that is very similar to Manager Monica's voice (or, Attacker Alice claims to be the personal assistant of Manager Monica); and instructs Victim Victor to immediately perform a wire transfer to Recipient Robert.

In a third example, Attacker Andrew sends to Victim Victor an email message, by utilizing an email spoofing mechanism, such that the email message appears to be incoming to Victim Victor from the genuine email address of Supplier Sam (e.g., from “Sam@Supplier.com”). Supplier Sam is a genuine supplier of Company Corp, and regularly sells goods or services to Supplier Sam. The spoofed email message notifies Victim Victor, that due to a recent hack into the bank account of Supplier Sam at Bank 1, new payments to Supplier Sam should be made to a new bank account that Supplier Sam has at Bank 2; and the spoofed email message further provides the data of that bank account at Bank 2, and further requests payment for a genuine invoice that is outstanding and that Supplier Sam had already sent to Company Corp. Optionally, the spoofed email may also mention to Victim Victor, that if payment is not received immediately for the outstanding invoice, a legal action to collect the debt would be immediately commenced, and/or further delivery of goods to Company Corp would be immediately stopped. Based on the incoming email message, which appears to be incoming from Supplier Sam, Victim Victor initiates an immediate same-day wire transfer of funds to the bank account in Bank 2, that he believes to belong to Supplier Sam; but which, in reality, belongs to (or is controlled by) Attacker Andrew (or by a co-conspirator thereof).

The Applicants have realized that some conventional banking systems may attempt, often unsuccessfully, to mitigate this type of attack. For example, the banking interface may present to Victim Victor an on-screen question, such as, “Did you confirm with this new Payee, by talking to him face-to-face or over the phone, that these are indeed the true bank account details of this new Payee”; and may allow the user, Victim Victor, to answer “yes” or “no”; and if he answers “no”, then the banking interface may block or freeze or deny the requested transaction, and may inform Victim Victor that according to bank policy and/or according to corporate policy (of Company Corp), he (Victim Victor) must obtain such face-to-face or telephonic confirmation of the bank account details from Supplier Sam, before the transaction can proceed. However, realized the Applicants, such conventional system does not suffice. In some situations, realized the Applicants, Victim Victor may respond with “yes” to the above question, even though he did not in fact verify (face-to-face or telephonically) with Supplier Sam the correctness or the authenticity of the new bank account details that Supplier Sam allegedly has at Bank 2. The Applicants have realized that this may occur in various situations or due to various reasons; for example, Victim Victor believes that Supplier Sam is unavailable for several hours (e.g., due to being located at a different time zone; e.g., Victim Victor and Company Corp are located in New York, with local time of 9 AM; and Supplier Sam is located in Los Angeles, which currently has local time of 6 AM and is thus not available telephonically); and/or because the spoofed email message from Supplier Sam appears to be legitimate and authentic, and appears to indeed mention a past invoice that is indeed genuine and legitimate; and/or because Victim Victor is honestly concerned that delaying the transaction for several hours (e.g., until the start of the business day in Los Angeles) would indeed cause irreparable damage to Company Corp, and/or may result in a personal negative consequence for Victim Victor for not immediately paying a genuinely outstanding invoice to a genuine regular supplier.

In a fourth example, Attacker Albert calls Victim Victor on the phone. Attacker Albert utilizes a telephone number spoofing mechanism, such that the “Caller ID” data that Victim Victor shows on his phone, indicates that the caller is “Supplier Sam”, and further indicates the genuine telephone number (corporate or personal) of Supplier Sam. In that phone conversation, Attacker Albert has a voice that is very similar to Supplier Sam's voice (or, Attacker Albert alleges to be the personal assistant of Supplier Sam); and instructs Victim Victor to immediately perform a wire transfer to the new bank account of Supplier Sam at Bank 2.

The Applicants have realized that conventional banking systems are often unable to detect or to adequately stop such fraud attempts or attacks. The Applicants have realized that this particular type of attacks or frauds, may be detected and/or mitigated by utilizing behavioral analysis, which monitors the interactions and the user-gestures of the user (Victim Victor), who is a genuine and legitimate and authorized user (e.g., and has authority to perform transactions in the bank account of Company Corp). For example, user gestures and/or behavior of the user Victim Victor, may be extracted or learned from input unit interactions (e.g., mouse movement, mouse clicks, mouse scrolling, keyboard typing, touch-pad gestures, touch-screen gestures, or the like) and/or from spatial properties of the end-user device that the user Victim Victor is utilizing to interact with the banking system. Such user gestures and interactions, as well as spatial device properties, may be monitored and analyzed, in real time or in near real time, by the system of some embodiments; and may enable the system to detect or to estimate the emotional state of the user Victim Victor; for example, enabling the system to estimate or to determine that the user has an estimated Hesitation Level that is greater than a pre-defined threshold value, or has a Confusion/Uncertainty Level that is greater than a pre-defined threshold value. The threshold value(s) may be, for example, based on past or historical user gestures or user interactions of Victim Victor himself (e.g., in the previous three months; or, as exhibited in the ten most-recent wire transfer banking sessions), and/or based on past or historical user gestures or user interactions of the general population or of a population segment (e.g., based on the average behavioral properties as exhibited by a pool of 5,000 users of bank accounts; or as exhibited by a pool of 6,000 Chief Financial Officers who utilize corporate bank accounts; or as exhibited in 7,000 wire transfer sessions that were performed by the general population; or as exhibited in 8,000 wire transfer sessions that were performed by CFOs who utilize corporate bank accounts).

For demonstrative purposes, some portions of the discussion above or herein may relate to fraud or attacks that are performed in relation to a bank account, or a funds transfer or money transfer or wire transfer; however, these are only non-limiting examples; and some embodiments may similarly be used in order to detect, prevent, handle and/or mitigate attacks or fraud attempts or fraudulent transactions that are performed (or attempted) in relation to other types of accounts and/or entities, for example, a securities account or a brokerage account (e.g., a spoofed email from the CEO instructs the CFO to wire funds out of a securities account or a brokerage account of Company Corp), a retailer account or an online merchant account or an e-commerce account (e.g., a spoofed email from the CEO instructs the CFO to immediately log-in to the corporate account of Company Corp at Amazon, and to immediately purchase an electronic gift card that would be sent by email to Recipient Robert), an online payment account (e.g., a spoofed email from the CEO instructs the CFO to immediately log-in to the PayPal account of Company Corp, and to immediately initiate an online payment to Recipient Robert), a crypto-currency account (e.g., a spoofed email from the CEO instructs the CFO to immediately log-in to the CoinBase account of Company Corp, and to immediately transfer 5 Bitcoins to Supplier Sam or to Recipient Robert as payment for a recent invoice), and/or other types of accounts or entities. For demonstrative purposes, such bank or financial institution or brokerage firm or payment processing firm or retailer may be referred to herein as “Institution”.

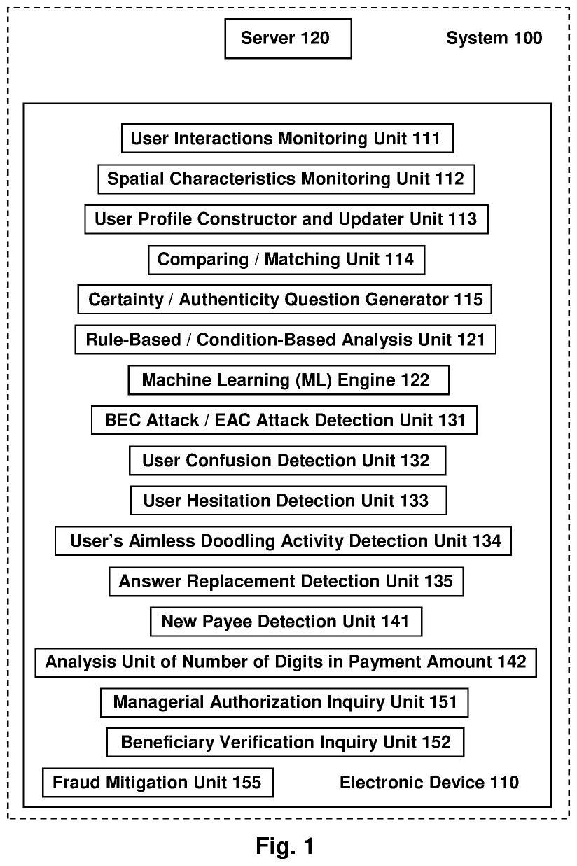

Reference is made to FIG. 1, which is a schematic block-diagram illustration of a system 100, in accordance with some demonstrative embodiments of the present invention. System 100 may be implemented using a suitable combination of hardware components and/or software components.

For example, a user utilizes his Electronic Device 110 (e.g., smartphone, tablet, desktop computer, laptop computer) to access and to interact with an online system or a computerized system or a Server 120 of an Institution (e.g., a bank, a banking institution, a retailer, an online retailer, an online merchant, or the like). The access is performed, for example, via a Web browser, or via a dedicated application or “app” or “mobile app” which may be installed and/or running on Electronic Device 110 of the user (e.g., a native app, an in-browser app, a downloadable or installable application, a mobile-friendly web-site or web-page, or the like).

The application that runs on the end-user electronic device, and/or the end-user device itself (e.g., via other applications that may be installed on it), utilizes a User Interactions Monitoring Unit 111 to monitor and log the interactions and the gestures performed by the end-user, as well as the dynamically-changing properties of the electronic device itself or of the entirety of the electronic device itself. For example, electronic device 110 monitors user interactions, mouse movements, mouse drags, mouse clicks and double-clicks, mouse-wheel scrolling, on-screen gestures performed on a touch-screen, touch-pad movements or gestures, taps or clicks or gestures (e.g., zoom-in, zoom-out, pinch-in, pinch-out, scroll) performed on a touch-screen or on a touch-pad, keystrokes, keyboard interactions, utilization (or lack of utilization) of keyboard shortcuts (e.g., CTRL-V for a Paste operation), whether a particular interactions was performed via the keyboard or via a mouse or via an on-screen tap or a via a touch-pad tap (for example: whether the user submitted an online form by pressing Enter on his keyboard, or by clicking or tapping a “Submit” button on the screen using a touch-screen or using the mouse or the touch-pad; or, whether the user navigate to a next on-screen Field in a form by pressing the Tab key on the keyboard, or by using the mouse or touch-pad to click on the next field, or by using the touch-screen to tap on the next field), and/or other interactions.

Electronic Device 110 further monitors and logs the particular characteristics of each such interaction or gesture; such as, the time-length of each interactions, the time-length or time-gap or time-interval between two (or several) consecutive interactions, the on-screen location within an on-screen field or an on-screen button that was clicked or tapped or selected (e.g., the right-third, or the left-third, of such button or field), the length of a drag or a movement of an on-screen pointer (e.g., on-screen distance of 100 pixels or 500 pixels), the curvature or the linearity or non-linearity of on-screen movements or drags (e.g., the user moved from Point A to Point B in a straight line, or in a curved line, or in a convex line, or in a concave line), the acceleration and/or deceleration and/or average speed that characterizes the user gestures and/or the on-screen movements of a pointer (e.g., the on-screen pointer moved from Point A to Point B at an average speed of 300 pixels per second; the user performed a touch-pad gesture with a particular value of initial acceleration; the longest or the average or the shortest stroke or mouse-stroke or touchpad-stroke or on-screen stroke of the user has a particular value or size or distance or speed or acceleration or deceleration; or the like).

In some embodiments, the monitoring and logging may be performed, for example, by a software component and/or a hardware component; or by a software module which may be an integral part or an internal part of the application or “app” of the retailer or bank or other Institution; by a code or program (e.g., implemented using HTML5 and/or JavaScript and/or CSS) which may be part of the application or “app” or web-site or web-page through which the end-user interacts with the computerized system of the Institution; or as a dedicated or stand-alone monitoring application or logging application (e.g., which may be required by the bank or the retailer or the Institution in order to improve or enhance security and to reduce fraud); as part of a web-browser; as a plug-in or add-on or extension to a web browser or to an application; as a hardware unit (e.g., similar to a hardware keylogger device), or as a hybrid hardware-and-software component; or the like. In some embodiments, the monitoring and logging may be performed at the end-user electronic device, and/or at a remote server which may be operated by the Institution itself (e.g., the bank itself, the retailer itself) or by a trusted third-party (e.g., a trusted entity that manages or provides security services or fraud-mitigation services for such bank or retailer or Institution).

Electronic Device 110 further monitors and logs, via a Spatial Characteristics Monitoring Unit 112, the spatial characteristics of the entirety of Electronic Device 110, immediately before a particular interaction or gesture (e.g., during the T1 milliseconds that preceded it), and/or during the interaction itself, and/or immediately after the interaction or gesture (e.g., during the T2 milliseconds that followed it); such as, data sensed or measured by or via one or more accelerometers of the electronic device, gyroscopes of the electronic device, compass units of the electronic device, device orientation sensor(s) and/or spatial orientation sensor(s) of the electronic device, or the like.

In some embodiments, optionally, a user profile may be constructed and/or updated, by a User Profile Constructor and Updater Unit 113, enabling the system to identify users based on a distinguishing collection or a differentiating collection of behavioral and/or biometric parameters or traits that characterize their interactions and/or that characterize the Electronic Device 110 during (or before, or after) their interaction. For example, the system may construct User Profile A for user Adam, indicating that user Adam typically or always presses the Enter key to submit an online form (rather than clicking an on-screen Submit button via a mouse or touch-pad or touch-screen), and that user Adam typically or always types data via a physical keyboard at an average typing speed of 72 characters per minute, and that user Adam typically or always moves the on-screen pointer in counter-clockwise curved lines. In contrast, the system may construct User Profile B for user Bob, indicating that user Bob typically or always utilizes the touch-screen to submit an online form (rather than pressing Enter on his keyboard), and that user Bob typically or always types data via a physical keyboard at an average typing speed of 23 characters per minute, and that user Bob typically or always moves the on-screen pointer in straight lines or in clockwise curved lines. In some embodiments, “typically” may be defined or configured by utilizing comparison operations to pre-defined threshold values or ranges-of-values; for example, the system may define that if a user performs a particular operation at a particular manner for at least N percent of the times (e.g., N being, for example, 80 or 90 or other pre-defined threshold value) then the user should be regarded or defined as a user who “typically” performs that particular operation at that particular manner. In some embodiments, optionally, the value of a parameter may be established as a “typical” value for that particular parameter (e.g., typing speed), by utilizing an Average function that averages the values of that parameter (e.g., during the N most-recent usage sessions of that user; or, during the M most-recent wire transfer transactions of that user, or during the M most-recent transactions of a particular transaction-type of that user), or by utilizing a Median value, or by utilizing other suitable mathematical functions and/or statistical functions.

The system may thus be able to differentiate and distinguish among users, based on characteristics of their fresh or current or recent gestures and/or interactions, which may be compared or matched against previous or past or historical gestures and/or interactions, using a Comparing/Matching Unit 114. For example, if attacker Anna logs-in to the bank account of legitimate user Bob (e.g., by utilizing stolen credentials that attacker Anna has obtained and that belong to legitimate user Bob), then the system may detect that the interactions and gestures that are performed by attacker Anna do not sufficiently match the profile that was created for the legitimate user Bob, and/or do not sufficiently match the characteristics of previous or historical or past usage-sessions in which user Bob was logged-in and interacted with his account, and/or sufficiently match one or more pre-defined playbooks or patterns of interactions that characterize the interactions of a computer-savvy hacker or attacker. The system of some embodiments may thus trigger a fraud alert or a possible-fraud alert, and/or may trigger or launch one or more pre-defined fraud mitigation operations.

In some embodiments, “sufficiently match” may be defined or configured by utilizing comparison operations, relative to pre-defined threshold values or ranges-of-values; for example, the system may define that a fresh typing speed of 73 characters per minute is “sufficiently matching” to a historical or previously-recorded typing speed of 75 characters per minute, since the difference between the two values is smaller than N percent (e.g., N being 5 or 10 percent points); whereas, the system may define that a fresh typing speed of 26 characters per minute is “not sufficiently matching” or “not matching” to a historical or previously-recorded typing speed of 75 characters per minute, since the difference between the two values is greater than the threshold value of N percent.

The system may further monitor, log, and utilize behavioral signals and behavioral characteristics that the system observes and extracts, as well as patterns and order-of-operations or sequence-of-operation by users. For example, the system may monitor and detect that legitimate user Bob, when accessing his bank account online, always (or typically; for example, in at least 90% or at least N percent of his online banking sessions in the past 60 days) starts his usage session by reviewing his current balances, then proceeds to pay utility bills, and then proceeds to perform wire transfers. The system may detect and determine that this pattern was utilized by user Bob in at least N percent (e.g., at least 80 percent, or other threshold value) of his usage-sessions that involved a wire transfer. Later, attacker Anna may log-in to the online bank account of user Bob; and the system detects that the current user of the online bank account of user Bob has immediately started a wire transfer, in contrast with the historical or previous or regular pattern of usage sessions of the legitimate owner Bob. The system of the present invention may thus trigger a fraud alert or a possible-fraud alert, and/or may trigger or launch one or more pre-defined fraud mitigation operations.

In accordance with some embodiments, server 120 may be configured to generate and present a Certainty/Authenticity Question, that may be posed or conveyed to the current user of Electronic Device 110 if one or more pre-defined conditions hold true. For example, Server 120 may be configured that for any wire transfer request, or for any wire transfer request to a New Payee, or for any wire transfer request in a monetary amount that is greater than D dollars, or for any wire transfer request in which the Payee is located in a particular Country, a Certainty/Authenticity Question would be generated or raised or served; such that Electronic Device 110 would show to its current user a question such as, “Did you obtain face-to-face or telephonic confirmation from your Manager for this requested transaction?”, or “Did you verify telephonically or face-to-face with this New Payee the bank account details of this New Payee?”. This may be performed by a Certainty/Authenticity Question Generator 115, or by a Certainty/Authenticity Notification Generator or other suitable unit; which is shown (for demonstrative purposes) as part of Electronic Device 110, although it may be implemented as a server-side unit in Server 120, or as a hybrid unit which operates partially on Server 120 and partially on Electronic Device 110.

Electronic Device 110 may then monitor analyze the behavior of its user, as well as the spatial properties of Electronic Device 110 itself; particularly in the first N seconds (e.g., the first 3 or 5 or 10 seconds) that immediately follow the generating and the displaying (or the conveying) of the Certainty/Authenticity Question, and/or during the time period that begins at the generation and the display (or conveyance) of the Certainty/Authenticity Question and ends at the user providing his response to the Certainty/Authenticity Question. Electronic Device 110 may analyze that particular portion of the monitored data, in this particular context of the usage session, in real time or in near real time; and may detect or estimate or determine one or more user emotions or user state-of-mind traits (e.g., confusion; uncertainty; doubtfulness; anxiety; or in contrast, peacefulness, calmness, lack of anxiety, lack of confusion, high level of focus and attention); and may utilize such estimates in order to determine whether or not the user's response to the Certainty/Authenticity Question should be trusted as reliable, or (in contrast) should be regarded as a user's attempt to “brush off” or to merely bypass (e.g., using an untrue response) the Certainty/Authenticity Question with a “yes” response that probably does not reflect the reality.

Some embodiments made utilize, monitor, and analyze one or more of the following parameters or values, in order to reach a decision or a determination as to whether the user's response to the Certainty/Authenticity Question is indeed true or is false. (1) The average or median typing speed, at which the user types data via his keyboard; and/or detected patterns or rhythms of typing, or detection of a set of characters that are typed slower or faster, or the average or median speed or time-length of keypresses; wherein these measures may be monitored and calculated on a per-field basis, or per-form basis, or per-screen basis, across a single field or across multiple fields, and including also transitions between fields or among GUI elements. (2) The standard deviation or the median of the typing speed of the user, within a particular field, or within some or all of the fields in a screen or in an entire form or within an entire usage session, or by taking into account comparisons among fields or among screens or among forms for the same user. (3) The average or median duration of a mouse-click that the user performs using his mouse. (4) The standard deviation of the duration of a mouse-click that the user performs. (5) The turn frequency of the mouse, or the frequency in which the mouse turns or changes its general direction of movement (e.g., from eastbound to westbound; or, from eastbound to southbound). (6) The ratio of idleness to activity, or the ratio of idle time to active time; or the proportion of time (out of the entire time-length of the entire usage-session) that is spent without any mouse activity and without any keyboard activity and without any touch-pad activity and without any or touchscreen activity; or the ratio of active time to the entire usage session time length, or relative to the aggregate time in which those input units were not used. (7) The number of activity pauses that were exhibited during a usage session. (8) The number of activity pauses that have a time-length that is greater than a pre-defined time period (e.g., of 3 seconds, or of N seconds) and thus indicate long gaps in user activity. (9) The frequency of such long gaps in user activity, or of such activity pauses, within a single usage session or within a time period of N seconds. (10) The average or median speed of movement of the mouse or the on-screen pointer or the touchpad pointer. (11) The number or the frequency of “doodles” or doodling activity that is detected, such as, purposeless or aimless motions, or purposeless movements of the on-screen pointer, that are typically performed by a user who is bored or confused or is not paying attention or is not focused or is non-attentive or is distracted. (12) The efficiency of mouse movements (or touch-pad gestures) between clicks or taps; namely whether a mouse movement took the on-screen pointer directly from a first on-screen click point to a second on-screen click-point, in a generally linear and straight movement, or (in contrast) whether the mouse movement was inefficient and between these two click-points in a curved manner or through an entirely different on-screen region before reaching the second click-point (13) The total distance (e.g., in pixels, or in centimeters) that was traveled by the on-screen pointer or the mouse or the touchpad. (14) The ratio between (i) the aggregate time that the on-screen pointer was not more than N pixels away from the most-recent on-screen click-point, and (ii) the aggregate time that the on-screen pointer was at least N pixels away from such on-screen click-point; or other ratio between on-screen regions that were visited and clicked, and on-screen regions that were visited by were not clicked. (15) The number or the frequency or the timing of pauses in user activity immediately prior to a click or tap using the mouse or the touchpad or the touchscreen. (16) The number of pauses during active typing, and the frequency of such typing pauses, and the time-length of such typing pauses during active typing. (17) The frequency of mouse clicks or mouse taps, or taps or clicks performed using a touchpad or a touch-screen; such as, during a particular time period of N seconds, or during an entire usage session, or during interaction with a particular page or a particular form of the interface or the system. (18) The number or the count, or the frequency, of backspace keystrokes or delete keystrokes or other corrective operations that are inputted or performed by the user. (19) Whether or not a new payee is defined and is utilized for a current transaction or wire transfer. (20) The number of digits of which the transaction amount consists, and this may be obtained or analyzed without necessarily knowing the actual monetary amount being transferred or transacted, for example, in order to protect or preserve privacy or confidentiality of the transaction and the parties, in some embodiments that are implemented by a third-party security provider or fraud detection provider which may be external from the Institution itself. (21) The time length, in minutes or in seconds, of the usage session. (22) The transaction ID which is utilized in order to identify the particular transaction at hand. (23) The country of destination of a wire transfer, or of a transaction, or of the beneficiary of the transaction, or of a recipient of the funds, or of a recipient of any benefit from the transaction. (24) The number of pages or contexts that were visited on the website or on the app during this usage session; and the particular type or identity of those pages that were visited; such as, whether the user has visited “non-risky” page, such as a Help page or an “About Us” page or an “F.A.Q.” page, or has visited a medium risk page (e.g., a “Check My Balance” page), or has visited a high risk page (e.g., a “Transfer Funds” page). (25) The number, or the ratio, of contexts or pages that are considered risky, relative to the entire number of pages or contexts that were visited in this user's usage session; for example, if the user visited four pages on the website which are non-risky and only one page that is risky, then this ratio is 80 percent. (26) The ratio of non-activity time periods, to the aggregate time period post the login; for example, whether N percent of the post-login time has exhibited active interactions (keystrokes, mouse movements, touchpad gestures) or has exhibited idleness (no input-unit activity). (27) Whether a new payee has been added to the system in the last N minutes or hours. (28) The number of unsuccessful log-in attempts that were performed (and failed) during the log-in process that yielded the current logged-in session. (29) Whether or not the beneficiary account number or the recipient's name, or other identifier (e.g., address, phone number) of the recipient or that is related to the recipient, were already flagged in advance as possibly-fraudulent or as known to be fraudulent, by this banking institution or by another banking institution or by a third-party such as a security provider or a fraud detection provider.

In some embodiments, the analysis of user interactions, user gestures and/or the characteristics of the end-user device, may be performed by a Rule-Based/Condition-Based Analysis Unit 121, which may utilize or apply one or more pre-defined rules or conditions in order to reach one or more pre-defined analysis results; for example, in a deterministic process that is guided by such rules and conditions.

In a first non-limiting example, the following set of rules or conditions may be used: (I) if the typing speed of the user is smaller than N characters per second, and also (II) if the number of delete/backspace keystrokes is greater than M, and also (III) if the total distance (e.g., in pixels) traveled by the on-screen cursor between the time-point in which the Certainty/Authenticity question was conveyed until the time-point in which it was answered is greater than P pixels; then, the analysis result is that the user interactions and gestures exhibit hesitation at a level that is greater than a threshold value and thus a determination of False response is generated, indicating that the user's positive response is false or untrue.

In a second non-limiting example, the following set of rules or conditions may be used: (I) if the number of activity pauses, within 30 seconds of the usage session, is greater than N, wherein each activity pause is defined as a time-period of at least M seconds without any input-unit interaction; and also (II) if the on-screen distance that was traveled by the on-screen pointer, from the “Submit Transaction” button to the “Confirm” button, is at least P percent greater than the shortest distance between these two on-screen locations; and also (III) the ratio of idleness to activity, during the time period between the time-point in which the Certainty/Authenticity question was conveyed until the time-point in which it was answered is greater than R; then, the analysis result is that the user interactions and gestures exhibit hesitation at a level that is greater than a threshold value and thus a determination of False response is generated, indicating that the user's positive response is false or untrue.

Additionally or alternatively, the analysis of user interactions, user gestures and/or the characteristics of the end-user device, may be performed by a Machine Learning (ML) Engine 122. For example, a training dataset may be manually prepared, including a large number (e.g., 1,000) of transactions that are known (e.g., based on manual verification with each customer in each transaction) as transactions in which the user's Positive Response was indeed true; and further including another large number (e.g., 1,000) of transactions that are known (e.g., based on manual verification with each customer in each transaction) as transactions in which the user's Positive Response was actually false (e.g., without necessarily resulting in a fraudulent transaction). The dataset may further include the above-mentioned characteristics of user interactions and/or user gestures and/or end-user device properties, that were monitored or collected or sensed or observed during each one of the transactions in the training dataset. The ML Engine 122 may self-learn from the dataset, and may construct a Classifier (or, a set or group of classifiers) that is able to receive the characteristics of user interactions and/or user gestures and/or end-user device properties for a new transaction that is currently undergoing inspection or processing or fulfillment (e.g., a freshly-submitted transaction request), and may generate as output a classification of such characteristics as belonging to the class of “The user's positive response is true” or to the class of “The user's positive response is false”.

In some embodiments, a method comprises: (a) receiving from an end-user device a user request to perform an online transaction on behalf of a corporate entity; (b) monitoring user gestures and user interactions of said user, and performing analysis of said user gestures and user interactions; (c) based on said analysis, generating a signal indicating a determination that said user has entered said online transaction based on a fraudulent message that said user received from a third-party. Some embodiments may thus detect, specifically, a Business Email Compromise (BEC) attack or an Email Account Compromise (EAC) attack, by a BEC Attack/EAC Attack Detection Unit 131; namely, an attack in which a victim is induced or is “tricked” into performing or commanding or ordering an online payment or an online transaction, based on an incoming email message that is spoofed to appear as it if originates (i) from a legitimate vendor or supplier of goods and/or services, or (ii) from a legitimate manager or signatory or authorized person in the corporate entity of the paying party.

In some embodiments, step (b) comprises: detecting in said analysis that monitored user gestures and user interactions are indicative of user confusion; wherein step (c) comprises: based on detected user confusion, determining that said user has entered said online transaction based on a fraudulent message that said user received from a third-party. The user confusion may be detected by a User Confusion Detection Unit 132 (or similar component), which may apply one or more pre-defined rules or conditions to detect user confusion based on user interactions and/or user gestures and/or spatial properties of the electronic device utilized by the user. As non-limiting examples, User Confusion may be detected or estimated based on, for example: (i) detecting that the user clicked or tapped, at least one time, or at least N times within T seconds on non-active parts or regions or elements of the screen presented to the user (wherein N is a pre-defined threshold number, and wherein T is a pre-defined threshold number; for example, N being 3 times, and T being 120 seconds), such as, the user clicks on regular text on the screen that is non-hyperlinked and is not a GUI element; (ii) detecting that the user has entered only numerical data into a text field that is expected to have at least some alphabetic (non-numeric) characters, for example, the user entered “12345” into the field of “City of Payee”, or, the user has performed this operation at least N times within T seconds; (iii) detecting that the user has replaced or deleted or corrected at least M data-items (or words, or characters, or strings) within fields of a form, within T seconds, for example, the user has replaced or corrected two times the content of the “City of Payee” field before pressing the Submit button; (iv) detecting that the user has submitted the form at least N times within T seconds, even though the user repeatedly receives alert signals that at least one field was not filled out, or was filled out incorrectly (e.g., the content of an email address field lacks the character “@” therein); and/or other pre-defined rules that indicate User Confusion; (v) the user is continuously rotating, spatially, his electronic device, while filling out a form; or repeatedly performing such device spatial rotation or spatial spinning at least N times within T seconds; (vi) the user repeatedly changes his electronic device from being in Portrait orientation to being in Landscape orientation, and vice versa, or performs such changes at least N times within T seconds; (vii) the user has clicked on tap on a Help button or a Help GUI element (e.g., a small question mark character that is located next to some field in the form and provides additional data about filling each field, with field-specific help), or the user has done so at least N times within T seconds; (viii) the user exhibits conflicting selections of enters conflicting data; for example, the user enters “Miami” for the payee city, but also enters “Texas” (instead of Florida) for the payee state, and such contradiction or conflict may be indicative or user confusion; and/or other suitable rules for detecting or estimating User Confusion.

In some embodiments, step (b) comprises: detecting in said analysis that monitored user gestures and user interactions are indicative of user hesitation; wherein step (c) comprises: based on detected user hesitation, determining that said user has entered said online transaction based on a fraudulent message that said user received from a third-party. The user hesitation may be detected by a User Hesitation Detection Unit 133 (or similar component), which may apply one or more pre-defined rules or conditions to detect user hesitation based on user interactions and/or user gestures and/or spatial properties of the electronic device utilized by the user. As non-limiting examples, User Confusion may be detected or estimated based on, for example: (i) detecting that the user has replaced or deleted or corrected at least M data-items (or words, or characters, or strings) within fields of a form, within T seconds, for example, the user has replaced or corrected two times the content of the “City of Payee” field before pressing the Submit button; (ii) detecting that the user enters a Payment Amount, by typing its digits slower than a pre-defined threshold value; for example, the user entered the payment amount “5000” during a time-period of 12 seconds in total, such that approximately 3 seconds elapsed between each two consecutive digits, indicating possible hesitation of the user, as typically the typing of the string “5000”, particularly having three consecutive Zero digits, does not require 12 seconds of typing with long time-gaps between digits; (iii) the user exhibits a time-gap of at least T seconds, on average, in moving between fields on the same form, or in filling-out fields in the same form; such as, the user has an average time-gap of at least 45 seconds, in filling a first field (Payee First Name) and then filling a second field (Payee Family Name) and then filling a third field (Payment Amount); (iv) the user exhibits a Median time-gap between filling-out of fields, that is not excessively long (e.g., the Median time-gap is under 10 seconds), but the Average of those time gaps is larger than a pre-defined threshold (e.g., greater than 60 seconds), indicating that possible user hesitation has prolonged the time-gap prior to entry of a particular field out of several fields on the form; and/or other suitable rules for detecting or estimating User Hesitation.

In some embodiments, step (b) comprises: detecting in said analysis that monitored user gestures and user interactions are indicative of aimless user doodling activity with an input-unit; wherein step (c) comprises: based on detected aimless user doodling activity with said input-unit, determining that said user has entered said online transaction based on a fraudulent message that said user received from a third-party. The user's aimless doodling activity may be detected by a User's Aimless Doodling Activity Detection Unit 134 (or similar component), which may apply one or more pre-defined rules or conditions to detect user's aimless doodling activity based on user interactions and/or user gestures and/or spatial properties of the electronic device utilized by the user. As non-limiting examples, user's aimless doodling activity may be detected or estimated based on, for example: (i) detecting that the on-screen pointer has been moved, in generally circular motions or routes, via a mouse or touch-pad, for at least T consecutive seconds (e.g., for at least 4 seconds), or for at least N times of T consecutive seconds (e.g., for at least 3 times of 2 consecutive seconds per occurrence); optionally utilizing a minimum on-screen radius or diameter to define such aimless doodling, such as, a radius of at least 150 on-screen pixels; (ii) detecting that the on-screen pointer has been moved, in generally horizontal motions or routes, via a mouse or touch-pad, for at least T consecutive seconds, repeatedly from left to right and vice versa (e.g., the user moves the on-screen pointer only right and left, in an alternating manner, for at least 5 consecutive seconds), or for at least N times of T consecutive seconds (e.g., for at least 4 times of 2.5 consecutive seconds per occurrence); optionally utilizing a minimum on-screen distance to define such aimless horizontal doodling, such as, a horizontal distance of at least 180 on-screen pixels per each such horizontal move; (iii) detecting that the on-screen pointer has been moved, in generally vertical motions or routes, via a mouse or touch-pad, for at least T consecutive seconds, repeatedly from the upper side of the screen towards the lower side of the screen and vice versa (e.g., the user moves the on-screen pointer only up and down, in an alternating manner, for at least 5 consecutive seconds), or for at least N times of T consecutive seconds (e.g., for at least 4 times of 2.5 consecutive seconds per occurrence); optionally utilizing a minimum on-screen distance to define such aimless vertical doodling, such as, a vertical distance of at least 170 on-screen pixels per each such horizontal move; (iv) detecting that the on-screen pointer has been moved, via a mouse or touch-pad, for at least T consecutive seconds and/or for at least N times, along a repeating route; for example, detecting that the on-screen pointer is moved for three consecutive times in the same on-screen rectangular track, or within not more than P pixels (e.g., not more than 25 pixels) from a particular on-screen rectangular pattern; optionally utilizing a minimum pixel size of such repeated movement; and/or other suitable rules or conditions, and particularly when such doodling activity is not accompanied by a mouse-click or a touch-pad tap or by a keystroke.

In some embodiments, step (b) comprises: detecting in said analysis that monitored user gestures and user interactions are indicative of an answer replacement operation (or, indicating excessive replacement or correction or deletion, of already-entered data by the user, prior to submission of the form or command), in which the user had selected a negative answer and then replaced the negative answer with a positive answer; wherein step (c) comprises: based on the detected answer replacement operation, determining that said user has entered said online transaction based on a fraudulent message that said user received from a third-party. The detection may be performed by an Answer Replacement Detection Unit 135 (or similar component), which may apply one or more pre-defined rules or conditions to detect such replacement based on user interactions and/or user gestures and/or spatial properties of the electronic device utilized by the user. As non-limiting examples, such detection may be based on, for example: (i) detecting that the user has selected “no” in response to a question that inquires whether the user has obtained Managerial Approval for this specific transaction, and then, within T seconds, has changed his answer from “no” to “yes”; (ii) detecting that the user has selected “no” in response to a question that inquires whether the user has confirmed telephonically with the payee this specific transaction and/or the payee's bank account information, and then, within T seconds, has changed his answer from “no” to “yes”; (iii) detecting that the user has selected “no” in response to a question that inquires whether the user has obtained face-to-face (or non-electronic, or non email based) Managerial Approval for this specific transaction, and then, within T seconds, has changed his answer from “no” to “yes”; (iv) detecting that the user has replaced or deleted or corrected at least M data-items (or words, or characters, or strings) within fields of a form, within T seconds, before pressing the Submit button; and/or other suitable rules or conditions.

In some embodiments, the analysis of step (b) further takes into account a signal indicating that said transaction is a payment to a new payee; such as, generated by a New Payee Detection Unit 141 which may monitor the adding of new payees (and the time and date at which each payee is added) and may detect that a current transaction is requested towards a recently-added payee or to a new payee that was added within the past M minutes (e.g., within the past 15 minutes, or within the past 120 minutes); wherein said signal is utilized in said analysis specifically for reaching a determination that said user has entered said online transaction based on a fraudulent message that said user received from a third-party. The Applicants have analyzed many dozens of user-related or transaction-related features, and have realized that an indication that the payee or beneficiary of the transaction is a new payee (or a new beneficiary, or a new recipient), such as a payee that has just been defined or added in the current usage-session and/or immediately prior to initiating this transaction and/or in the past T seconds (e.g., in the most-recent 300 seconds), is a signal that is specifically indicative of BEC or EAC attack, by itself and/or in conjunction with analysis of other signals or behavioral indicators or user-specific characteristics that were extracted. The Applicants have realized that initiation of a transaction or a wire transfer or a payment to a new payee, may have been utilized in the past as a general signal which may assist in generally raising an alert for increased risk or for a greater risk of fraud; however, realized the Applicants, this specific signal, of making a payment or a transaction to the benefit of a new payee (or new recipient, or new beneficiary) has Not been utilized, by conventional systems, as a Signal indicating specifically a BEC attach or an AEC attack.

In some embodiments, the analysis of step (b) further takes into account a signal indicating a number of digits in a payment amount of said transaction; such as, generated by an Analysis Unit of Number of Digits in Payment Amount 142, which tracks or monitors specifically the monetary amount of the transaction, and particularly tracks or extracts only the number of digits (e.g., that are to the left side of a decimal point); wherein said signal is utilized in said analysis specifically for reaching a determination that said user has entered said online transaction based on a fraudulent message that said user received from a third-party. The Applicants have analyzed many dozens of user-related or transaction-related features, and have realized that an indication of the Number of Digits in the transaction amount or the payment amount, is a signal that is specifically indicative of BEC or EAC attack, by itself and/or in conjunction with analysis of other signals or behavioral indicators or user-specific characteristics that were extracted. The Applicants have realized that initiation of a transaction or a wire transfer or a payment having a payment amount of at least D digits (e.g., at least 5 digits, or at least 4 digits; wherein D is a pre-defined threshold value that can be configured in each system; wherein D is the number of digits to the left side of the decimal point), may be specifically useful for BEC/AEC attack detection. In contrast, the payment amount by itself might have been utilized in the past as a general signal which may assist in generally raising an alert for increased risk or for a greater risk of fraud; however, realized the Applicants, this specific signal, of making a payment or a transaction having an amount that has at least D digits, has Not been utilized, by conventional systems, as a Signal indicating specifically a BEC attach or an AEC attack. The Applicants have further realized that this specific signal does Not require the fraud-prevention system of some embodiments to know or to receive or to obtain the actual Payment Amount, or even the Monetary Range to which such payment amount belongs; but rather, the Number of Digits by itself may suffice as a signal that can assist in efficiently detecting a BEC attack or an AEC attack, without obtaining or receiving or knowing the actual payment amount or its range, and thus providing increased privacy and security to the system, and also enabling a third-party security service provider or fraud-mitigation provider to efficiently provide mitigation of BEC/AEC attacks to financial entities (e.g., banks, brokerage firms, credit unions, credit card companies, or the like) without receiving from such entities the Payment Amount or the Payment Range.

In some embodiments, step (b) comprises: (b1) generating a notification that requires the user to indicate, via his end-user device, whether or not the user obtained managerial authorization for performing said online transaction on behalf of said corporate entity; and causing the end-user device of said user to convey said notification to said user; for example, using a Managerial Authorization Inquiry Unit 151, which may generate such question or inquiry or notification to the commanding user, inquiring whether he has obtained non-email managerial authorization or face-to-face managerial authorization or telephonic managerial authorization (e.g., and particularly, a telephonic managerial authorization in which the acting user or the commanding user, who provides the transaction details, was the party who initiated the telephonic call towards the manager to obtain the managerial authorization by phone, rather than merely receiving an incoming telephonic authorization which may be spoofed from a spoofed telephone number); (b2) monitoring user gestures of said user and user interactions of said user, at least from a first time-point in which said notification is conveyed to said user via his end-user device, and at least until a second-time-point in which said user conveys a positive answer to said notification via his end-user device; (b3) receiving said positive answer from said user; (b4) performing an analysis of user gestures and user interactions, that were monitored at least from the first time-point until the second time-point; and generating an analysis result which indicates that the positive answer from said user is false, based on one or more analyzed metrics that correspond to characteristics of the user gestures and user interactions.

In some embodiments, step (b4) comprises: performing the analysis of user gestures and user interactions, and generating a determination that the user gestures and user interactions exhibit user hesitation in responding to the notification; and based on said determination of exhibited user hesitation, generating an analysis result which indicates that the positive answer from said user is false.

In some embodiments, step (b4) comprises: performing the analysis of user gestures and user interactions, and generating a determination that the user gestures and user interactions exhibit aimless doodling by the user with an input unit of the end-user device in response to the notification; and based on said determination or exhibited aimless doodling, generating an analysis result which indicates that the positive answer from said user is false.

In some embodiments, step (b4) comprises: performing the analysis of user gestures and user interactions, and generating a determination that the user gestures and user interactions exhibit selection of a negative answer and then replacement of the negative answer with a positive answer; and based on said determination of replacement of negative answer by positive answer, generating an analysis result which indicates that the positive answer from said user is false.

In some embodiments, step (b4) comprises: performing an analysis by feeding multiple characteristics, extracted from the user gestures and user interactions, into a Machine Learning (ML) unit that is trained to classify user responses to said notification as true or false based on multiple characteristics extracted from user gestures and user interactions; and receiving from said ML unit a classification of said user responses as either (i) being classified as false or (ii) being classified as true.

In some embodiments, step (b4) comprises: generating said analysis result, which indicates that the positive answer from said user is false, based on one or more analyzed metrics that correspond at least to: average value of typing speed, median value of typing speed, standard deviation value of typing speed.

In some embodiments, step (b4) comprises: generating said analysis result, which indicates that the positive answer from said user is false, based on one or more analyzed metrics that correspond at least to: a ratio between (i) a cumulative time-length within a usage session in which the user is idle and does not perform any user gestures, and (ii) a cumulative time-length within said usage session in which the user is active and performs user gestures.

In some embodiments, step (b4) comprises: generating said analysis result, which indicates that the positive answer from said user is false, based on one or more analyzed metrics that correspond at least to: a number of idle time-length period, that are exhibited by said user within a monitored time-period; wherein an idle time-length period is defined as a time-period of at least N seconds in which the user is idle and does not perform any user gestures; wherein N is a pre-defined positive number.

In some embodiments, step (b4) comprises: generating said analysis result, which indicates that the positive answer from said user is false, based on one or more analyzed metrics that correspond at least to: a generated score of efficiency of user interactions, that is based on a ratio between (i) actual on-screen distance that an on-screen pointer has traveled among on-screen interface elements to convey user inputs, and (ii) a sum of shortest on-screen distances that can be traveled among said on-screen interface elements.

In some embodiments, step (b4) comprises: generating said analysis result, which indicates that the positive answer from said user is false, based on one or more analyzed metrics that correspond at least to: a ratio between (i) a cumulative time-length within a usage session in which an on-screen pointer was located within active on-screen regions that are responsive to a click or a tap, and (ii) a cumulative time-length within said usage session in which the on-screen pointer was located within non-active on-screen regions that are non-responsive to clicks or taps.

In some embodiments, step (b4) comprises: generating said analysis result, which indicates that the positive answer from said user is false, based on one or more analyzed metrics that correspond at least to: a number of occurrences of an aimless doodling activity that is exhibited by the user by aimlessly moving an on-screen pointer without performing a click or a tap.

In some embodiments, step (b4) comprises: generating said analysis result, which indicates that the positive answer from said user is false, based on one or more analyzed metrics that correspond at least to: a frequency of occurrences of an aimless doodling activity that is exhibited by the user by aimlessly moving an on-screen pointer without performing a click or a tap.

In some embodiments, step (b4) comprises: generating said analysis result, which indicates that the positive answer from said user is false, based on one or more analyzed metrics that correspond at least to: a number of occurrences of corrective operations performed by the user, wherein a corrective operation is a user gesture that deletes or replaces a previously-gestured input.

In some embodiments, step (b4) comprises: generating said analysis result, which indicates that the positive answer from said user is false, based on one or more analyzed metrics that correspond at least to: a frequency of occurrences of corrective operations performed by the user, wherein a corrective operation is a user gesture that deletes or replaces a previously-gestured input.

In some embodiments, the method monitors and utilizes, for said analysis, at least one of: (i) user gestures performed via a mouse, (ii) user gestures performed via a touch-pad, (iii) user gestures performed via a touch-screen.

In some embodiments, the method further comprises: (d) blocking or unauthorizing, at least temporarily, said online transaction that was requested via said end-user device on behalf of said corporate entity. These operations may be performed, for example, by a Fraud Mitigation Unit 155, which may select and enforce (or apply, or activate, or trigger, or execute) one or more pre-defined fraud mitigation operations, based on one or more pre-defined fraud mitigation rules or conditions, selected from a pool or set of pre-defined fraud mitigation operations; for example, placing a temporary freeze or hold on a requested transaction; blocking or denying the requested transaction; blocking or black-listing a payee; placing a temporary freeze or hold on an account (e.g., a bank account, a securities account, an online purchase account); requiring the acting user (e.g., the user who entered the transaction data into the electronic device for the purpose of ordering or commanding the transaction) to perform two-step or two-factor or multiple-factor authentication, or to re-authenticate via an additional authentication factor or method; requiring the acting user to contact a customer service representative or a fraud department, telephonically or even face-to-face at a branch; generating and sending notifications or alerts or inquiries, by email and/or by SMS text and/or by telephone and/or by other suitable methods, to one or more other persons or parties that are associated with the account (e.g., other signatories on the account; other persons or user who are also authorized to access the account), and/or sending to such additional person(s) a request for their additional approval; and/or selecting and performing other suitable fraud mitigation operations.

In some embodiments, a method comprises: (a) receiving from an end-user device a user request to perform an online banking transaction that transfers funds to a particular beneficiary; wherein the user request comprises data identifying a target bank account of said particular beneficiary; for example, using a Beneficiary Verification Inquiry Unit 152, which may generate such question or inquiry or notification to the commanding user, inquiring whether he has performed non-email verification or face-to-face verification or telephonic verification of the details of the beneficiary or payee or recipient or vendor, including its bank account details (e.g., and particularly, a telephonic managerial authorization in which the acting user or the commanding user, who provides the transaction details, was the party who initiated the telephonic call towards the manager to obtain the managerial authorization by phone, rather than merely receiving an incoming telephonic authorization which may be spoofed from a spoofed telephone number); (b) monitoring user gestures and user interactions of said user, and performing analysis of said user gestures and user interactions; (c) based on said analysis, generating a signal indicating a determination that said user has entered said online transaction based on a fraudulent message that said user received from a third-party. In some embodiments, step (b) comprises: (b1) generating a notification that requires the user to indicate, via his end-user device, whether or not the user performed a fresh verification with said particular beneficiary, via a non-email verification means, of the data identifying the target bank account of said particular beneficiary; and causing the end-user device of said user to convey said notification to said user; (b2) monitoring user gestures of said user and user interactions of said user, at least from a first time-point in which said notification is conveyed to said user via his end-user device, and at least until a second-time-point in which said user conveys a positive answer to said notification via his end-user device; (b3) receiving said positive answer from said user; (b4) performing an analysis of user gestures and user interactions, that were monitored at least from the first time-point until the second time-point; and generating an analysis result which indicates that the positive answer from said user is false, based on one or more analyzed metrics that correspond to characteristics of the user gestures and user interactions.

Some embodiments may ask the commanding user, whether he has obtained fresh non-email confirmation (e.g., telephonically or face to face) from a managerial entity, for performing the requested transaction; and may monitor the user's gestures and interactions in response to such query; and may determine, based on analysis of the user's gestures and interactions in response to such query, and/or based on analysis of the user's gestures and interactions during this usage session (and optionally while also comparing to historic user-specific behavioral characteristics), that the user's positive response to such inquiry is actually false; thereby enabling the system to trigger a possible-fraud alert and particularly a possible BEC attack signal or a possible AEC attack signal; which in turn may be used for triggering one or more pre-defined mitigation operations.

Some embodiments may ask the commanding user, whether he has obtained fresh non-email confirmation (e.g., telephonically, or face to face) from the beneficiary or recipient or payee, of the bank account details or other details of such beneficiary or recipient or payee; and may monitor the user's gestures and interactions in response to such query; and may determine, based on analysis of the user's gestures and interactions in response to such query, and/or based on analysis of the user's gestures and interactions during this usage session (and optionally while also comparing to historic user-specific behavioral characteristics), that the user's positive response to such inquiry is actually false; thereby enabling the system to trigger a possible-fraud alert and particularly a possible BEC attack signal or a possible AEC attack signal; which in turn may be used for triggering one or more pre-defined mitigation operations.

Some embodiments include a non-transitory storage medium or storage article, having stored thereon instructions that, when executed by a processor, cause the processor to perform a method as described above.

Some embodiments provide a system comprising: one or more processors to execute code; wherein the one or more processors are operably associated with one or more memory units to store code; wherein the one or more processors are configured to perform a method as described above or herein.

Some embodiments may utilize and/or may comprise, one or more units, components, operations, methods, systems, processes, parameters, data-items, analysis units, analysis results, fraud detection units, fraud mitigation units, and/or other elements which are described in any of the following publications, all of which are hereby incorporated by reference in their entirety: United States patent application publication number US 2021/0014236 A1; United States patent application publication number US 2020/0273040 A1; United States patent application publication number US 2021/0051172 A1; United States patent application publication number US 2021/0110014 A1; United States patent application publication number US 2017/0140279 A1; United States patent application number U.S. Ser. No. 17/359,579 (filed on Jun. 27, 2021).

It is noted that in accordance with the present invention, monitoring and/or analyzing of “user interactions” and/or “user gestures”, may further comprise the monitoring and/or analyzing of interactions, gestures, and/or sensed data that is collected shortly before or immediately before the actual interaction, and/or interactions, gestures, and/or sensed data that is collected shortly after or immediately after the actual interaction; in addition to the data collected or sensed or monitored during the interaction itself; wherein “shortly” or “immediately” may be configured or may be pre-defined based on threshold values (e.g., within 0.5 seconds, within 1 second, or the like).

The terms “mobile device” or “mobile electronic device” as used herein may include, for example, a smartphone, a cellular phone, a mobile phone, a smart-watch, a tablet, a handheld device, a portable electronic device, a portable gaming device, a portable audio/video player, an Augmented Reality (AR) device or headset or gear, a Virtual Reality (VR) device or headset or gear, or the like.

The term “input unit” or “pointing device” as used herein may include, for example, a mouse, a trackball, a pointing stick, a stylus, a joystick, a motion-sensing input device, a touch screen, a touch-pad, or the like.

The terms “device” or “electronic device” as used herein may include, for example, a mobile device, a non-mobile device, a non-portable device, a desktop computer, a workstation, a computing terminal, a laptop computer, a notebook computer, a netbook computer, a computing device associated with a mouse or a similar pointing accessory, a smartphone, a tablet, a smart-watch, and/or other suitable machines or devices.

The term “genuine user” as used herein may include, for example, an owner of a device; a legal or lawful user of a device; an authorized user of a device; a person who has legal authorization and/or legal right to utilize a device, for general purpose(s) and/or for one or more particular purpose(s); or the person who had originally defined user credentials (e.g., username and password) for performing an activity through the device.

The term “fraudulent user” as used herein may include, for example, any person who is not the “genuine user” of the device; an attacker; an intruder; a man-in-the-middle attacker; a man-in-the-browser attacker; an unauthorized user; an impersonator; a hacker; a cracker; a person attempting to hack or crack or compromise a security measure utilized by the device or by a system or a service or a website, or utilized by an activity or service accessible through the device; a fraudster; a human fraudster; a “bot” or a malware or an automated computerized process (e.g., implemented by using software modules and/or hardware components) which attempts to imitate human behavior or which attempts to act as if such “bot” or malware or process was the genuine user; or the like.

The present invention may be used in conjunction with various suitable devices and systems, for example, various devices that have a touch-screen; an ATM; a kiosk machine or vending machine that has a touch-screen; a touch-keyboard; a system that utilizes Augmented Reality (AR) or Virtual Reality (VR) components or AR glasses or VR glasses (e.g., Google Glass RTM) or other AR/VR helmet or headset or device; a device or system that may detect hovering gestures that do not necessarily touch on the screen or touch-screen; a hovering screen; a system or device that utilize brainwave analysis or brainwave control in which the user's brainwaves are captured or read and the user's brain may directly control an application on the mobile device; and/or other suitable devices or systems.

Some embodiments may identify multiple (different) users that utilize the same device, or the same account, before or after a typical user profile is built, or even during a training period in which the system learns the behavioral patterns. This may be used for detection of “friendly fraud” incidents, or identification of users for accountability purposes, or identification of the user that utilized a particular function in an Administrator account (e.g., optionally used in conjunction with a requirement that certain users, or users with certain privileges, may not share their password or credentials with any other person); or identification of a licensee in order to detect or prevent software piracy or unauthorized usage by non-licensee user(s), for software or products that are sold or licensed on a per-user basis or a per-seat basis.

Some embodiments may be utilized to identify or detect a remote access attacker, or an attacker or a user that utilizes a remote access channel to access (or to attack, or to compromise) a computerized service, or an attacker or cyber-attacker or hacker or impostor or imposter or “fraudster” that poses as a genuine user or as a true owner of an account, or an automatic script or “bot” or malware. Some embodiments may be used to differentiate or distinguish among, for example, an authorized or legitimate or genuine or human user, as opposed to an illegitimate and/or unauthorized and/or impostor human attacker or human user, and/or as opposed to a “bot” or automatic script or automated script or automated program or malware.

Some embodiments may be utilized for authenticating, or confirming the identity of, a user who is already logged-in or signed-in; or conversely, a user that did not perform (or did not yet perform, or did not complete) a log-in or sign-in process; or a user that did not successfully perform a log-in or sign-in process; or a user who is interacting with a computerized service prior to signing-in or logging in (e.g., filling-out fields in an electronic commerce website as part of checking-out as a guest), or during a log-in process, or after a log-in process; or to confirm the identity of a user who is already-logged-in, or who is not-yet logged-in, or who operates a system or service that does not necessarily require or utilize a log-in process.

The terms “service” or “computerized service”, as used herein, may be or may comprise any suitable service, or system, or device, which may require user authentication in order to authorize user access to it, or in order to authorize performance of one or more particular actions; including, but not limited to, for example, user authentication for accessing or operating or unlocking an electronic device (e.g., smartphone, tablet, smart-watch, laptop computer, desktop computer, smart-home device or appliance, Internet of Things (IoT) device) or service (e.g., banking service or web site, brokerage service or website, email account, web-mail, social network, online vendor, online merchant, electronic commerce website or application or “app”), or other system or platform that requires user authentication (e.g., entry into, or exit from, or passage through a gate or card-reader or turnstile; to unlock or open a device or a vehicle; to start or ignite a vehicle; to drive a vehicle).

Although portions of the discussion herein relate, for demonstrative purposes, to wired links and/or wired communications, some embodiments of the present invention are not limited in this regard, and may include one or more wired or wireless links, may utilize one or more components of wireless communication, may utilize one or more methods or protocols of wireless communication, or the like. Some embodiments may utilize wired communication and/or wireless communication.

The system(s) and/or device(s) of the present invention may optionally comprise, or may be implemented by utilizing suitable hardware components and/or software components; for example, processors, processor cores, Central Processing Units (CPUs), Digital Signal Processors (DSPs), circuits, Integrated Circuits (ICs), controllers, memory units, registers, accumulators, storage units, input units (e.g., touch-screen, keyboard, keypad, stylus, mouse, touchpad, joystick, trackball, microphones), output units (e.g., screen, touch-screen, monitor, display unit, audio speakers), acoustic microphone(s) and/or sensor(s), optical microphone(s) and/or sensor(s), laser or laser-based microphone(s) and/or sensor(s), wired or wireless modems or transceivers or transmitters or receivers, GPS receiver or GPS element or other location-based or location-determining unit or system, accelerometer(s), gyroscope(s), compass unit(s), device orientation sensor(s), network elements (e.g., routers, switches, hubs, antennas), and/or other suitable components and/or modules.

The system(s) and/or devices of the present invention may optionally be implemented by utilizing co-located components, remote components or modules, “cloud computing” servers or devices or storage, client/server architecture, peer-to-peer architecture, distributed architecture, and/or other suitable architectures or system topologies or network topologies.

In accordance with embodiments of the present invention, calculations, operations and/or determinations may be performed locally within a single device, or may be performed by or across multiple devices, or may be performed partially locally and partially remotely (e.g., at a remote server) by optionally utilizing a communication channel to exchange raw data and/or processed data and/or processing results.

Some embodiments may be implemented by using a special-purpose machine or a specific-purpose device that is not a generic computer, or by using a non-generic computer or a non-general computer or machine. Such system or device may utilize or may comprise one or more components or units or modules that are not part of a “generic computer” and that are not part of a “general purpose computer”, for example, cellular transceivers, cellular transmitter, cellular receiver, GPS unit, location-determining unit, accelerometer(s), gyroscope(s), device-orientation detectors or sensors, device-positioning detectors or sensors, or the like.

Some embodiments may be implemented as, or by utilizing, an automated method or automated process, or a machine-implemented method or process, or as a semi-automated or partially-automated method or process, or as a set of steps or operations which may be executed or performed by a computer or machine or system or other device.

Some embodiments may be implemented by using code or program code or machine-readable instructions or machine-readable code, which may be stored on a non-transitory storage medium or non-transitory storage article (e.g., a CD-ROM, a DVD-ROM, a physical memory unit, a physical storage unit), such that the program or code or instructions, when executed by a processor or a machine or a computer, cause such processor or machine or computer to perform a method or process as described herein. Such code or instructions may be or may comprise, for example, one or more of: software, a software module, an application, a program, a subroutine, instructions, an instruction set, computing code, words, values, symbols, strings, variables, source code, compiled code, interpreted code, executable code, static code, dynamic code; including (but not limited to) code or instructions in high-level programming language, low-level programming language, object-oriented programming language, visual programming language, compiled programming language, interpreted programming language, C, C++, C#, Java, JavaScript, SQL, Ruby on Rails, Go, Cobol, Fortran, ActionScript, AJAX, XML, JSON, Lisp, Eiffel, Verilog, Hardware Description Language (HDL), BASIC, Visual BASIC, Matlab, Pascal, HTML, HTML5, CSS, Perl, Python, PHP, machine language, machine code, assembly language, or the like.

In some embodiments, a system or an apparatus may comprise at least one processor or that is communicatively coupled to a memory unit and configured to operate execute code, wherein the at least one processor is further configured to perform the operations and/or the functionalities describes above.

Discussions herein utilizing terms such as, for example, “processing”, “computing”, “calculating”, “determining”, “establishing”, “analyzing”, “checking”, “detecting”, “measuring”, or the like, may refer to operation(s) and/or process(es) of a processor, a computer, a computing platform, a computing system, or other electronic device or computing device, that may automatically and/or autonomously manipulate and/or transform data represented as physical (e.g., electronic) quantities within registers and/or accumulators and/or memory units and/or storage units into other data or that may perform other suitable operations.

Some embodiments of the present invention may perform steps or operations such as, for example, “determining”, “identifying”, “comparing”, “checking”, “querying”, “searching”, “matching”, and/or “analyzing”, by utilizing, for example: a pre-defined threshold value to which one or more parameter values may be compared; a comparison between (i) sensed or measured or calculated value(s), and (ii) pre-defined or dynamically-generated threshold value(s) and/or range values and/or upper limit value and/or lower limit value and/or maximum value and/or minimum value; a comparison or matching between sensed or measured or calculated data, and one or more values as stored in a look-up table or a legend table or a legend list or a database of possible values or ranges; a comparison or matching or searching process which searches for matches and/or identical results and/or similar results among multiple values or limits that are stored in a database or look-up table; utilization of one or more equations, formula, weighted formula, and/or other calculation in order to determine similarity or a match between or among parameters or values; utilization of comparator units, lookup tables, threshold values, conditions, conditioning logic, Boolean operator(s) and/or other suitable components and/or operations.

Any reference above or herein to a parameter, typically indicated by a letter such as M or T or P or the like, may relate to a pre-defined or pre-configured parameter or constant or value or threshold value; or, in some embodiments, to a user-configurable or administrator-configurable value or threshold value; or, in some embodiments, to a dynamically-configurable and/or automatically-modified value or threshold value, which may be modified or adjusted by the system automatically or autonomously if one or more pre-defined conditions hold true and/or based on one or more pre-defined threshold modification rules which are enforced by a Parameters/Threshold Values Modification Unit or other suitable component. In a demonstrative embodiment, for example, the system administrator may configure or command the system to generate up to 50 possible-attack notifications or alerts per day, by performing analysis that is based on certain parameters (e.g., T seconds, N occurrences of an event, P pixels, or the like); if the system detects that more than 50 possible-attack notifications are generated per day, then the system may automatically modify or adjust one or more (or some, or all) of those parameters or threshold values (e.g., may decrease the threshold value for the T time-related parameter; may increase the threshold value of the N occurrences-counting parameter; or the like), in order to decrease the number or the frequency of possible-attack notifications that the system generates; and similarly, if the system detects that less than 50 possible-attack notifications are generated per day, then the system may automatically modify or adjust one or more (or some, or all) of those parameters or threshold values (e.g., may increase the threshold value for the T time-related parameter; may decrease the threshold value of the N occurrences-counting parameter; or the like), in order to increase the number or the frequency of possible-attack notifications that the system generates.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments”, “some embodiments”, and/or similar terms, may indicate that the embodiment(s) so described may optionally include a particular feature, structure, or characteristic, but not every embodiment necessarily includes the particular feature, structure, or characteristic. Furthermore, repeated use of the phrase “in one embodiment” does not necessarily refer to the same embodiment, although it may. Similarly, repeated use of the phrase “in some embodiments” does not necessarily refer to the same set or group of embodiments, although it may.

As used herein, and unless otherwise specified, the utilization of ordinal adjectives such as “first”, “second”, “third”, “fourth”, and so forth, to describe an item or an object, merely indicates that different instances of such like items or objects are being referred to; and does not intend to imply as if the items or objects so described must be in a particular given sequence, either temporally, spatially, in ranking, or in any other ordering manner.

Some embodiments may be used in, or in conjunction with, various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, a tablet, an on-board device, an off-board device, a hybrid device, a vehicular device, a non-vehicular device, a mobile or portable device, a consumer device, a non-mobile or non-portable device, an appliance, a wireless communication station, a wireless communication device, a wireless Access Point (AP), a wired or wireless router or gateway or switch or hub, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), or the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA or handheld device which incorporates wireless communication capabilities, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may comprise, or may be implemented by using, an “app” or application which may be downloaded or obtained from an “app store” or “applications store”, for free or for a fee, or which may be pre-installed on a computing device or electronic device, or which may be otherwise transported to and/or installed on such computing device or electronic device.

Functions, operations, components and/or features described herein with reference to one or more embodiments of the present invention, may be combined with, or may be utilized in combination with, one or more other functions, operations, components and/or features described herein with reference to one or more other embodiments of the present invention. The present invention may comprise any possible combinations, re-arrangements, assembly, re-assembly, or other utilization of some or all of the modules or functions or components that are described herein, even if they are discussed in different locations or different chapters of the above discussion, or even if they are shown across different drawings or multiple drawings.

While certain features of some demonstrative embodiments of the present invention have been illustrated and described herein, various modifications, substitutions, changes, and equivalents may occur to those skilled in the art. Accordingly, the claims are intended to cover all such modifications, substitutions, changes, and equivalents.

What is claimed is:

1. A method comprising:
(a) receiving from an end-user device a user request to perform an online transaction on behalf of a corporate entity;
(b) monitoring user gestures and user interactions of said user, and performing analysis of said user gestures and user interactions;
(c) based on said analysis, generating a signal indicating a determination that said user has entered said online transaction based on a fraudulent message that said user received from a third-party.

2. The method of claim 1,
wherein step (b) comprises: detecting in said analysis that monitored user gestures and user interactions are indicative of user confusion;
wherein step (c) comprises: based on detected user confusion, determining that said user has entered said online transaction based on a fraudulent message that said user received from a third-party.

3. The method of claim 1,
wherein step (b) comprises: detecting in said analysis that monitored user gestures and user interactions are indicative of user hesitation;
wherein step (c) comprises: based on detected user hesitation, determining that said user has entered said online transaction based on a fraudulent message that said user received from a third-party.

4. The method of claim 1,
wherein step (b) comprises: detecting in said analysis that monitored user gestures and user interactions are indicative of aimless user doodling activity with an input-unit;
wherein step (c) comprises: based on detected aimless user doodling activity with said input-unit, determining that said user has entered said online transaction based on a fraudulent message that said user received from a third-party.

5. The method of claim 1,
wherein step (b) comprises: detecting in said analysis that monitored user gestures and user interactions are indicative of an answer replacement operation, in which the user had selected a negative answer and then replaced the negative answer with a positive answer;
wherein step (c) comprises: based on the detected answer replacement operation, determining that said user has entered said online transaction based on a fraudulent message that said user received from a third-party.

6. The method of claim 1,
wherein the analysis of step (b) further takes into account a signal indicating that said transaction is a payment to a new payee;
wherein said signal is utilized in said analysis specifically for reaching a determination that said user has entered said online transaction based on a fraudulent message that said user received from a third-party.

7. The method of claim 1,
wherein the analysis of step (b) further takes into account a signal indicating a number of digits in a payment amount of said transaction;
wherein said signal is utilized in said analysis specifically for reaching a determination that said user has entered said online transaction based on a fraudulent message that said user received from a third-party.

8. The method of claim 1,
wherein step (b) comprises:
(b1) generating a notification that requires the user to indicate, via his end-user device, whether or not the user obtained managerial authorization for performing said online transaction on behalf of said corporate entity; and causing the end-user device of said user to convey said notification to said user;
(b2) monitoring user gestures of said user and user interactions of said user, at least from a first time-point in which said notification is conveyed to said user via his end-user device, and at least until a second-time-point in which said user conveys a positive answer to said notification via his end-user device;
(b3) receiving said positive answer from said user;
(b4) performing an analysis of user gestures and user interactions, that were monitored at least from the first time-point until the second time-point; and generating an analysis result which indicates that the positive answer from said user is false, based on one or more analyzed metrics that correspond to characteristics of the user gestures and user interactions.

9. The method of claim 8,
wherein step (b4) comprises:
performing the analysis of user gestures and user interactions, and generating a determination that the user gestures and user interactions exhibit user hesitation in responding to the notification; and based on said determination of exhibited user hesitation, generating an analysis result which indicates that the positive answer from said user is false.

10. The method of claim 8,
wherein step (b4) comprises:
performing the analysis of user gestures and user interactions, and generating a determination that the user gestures and user interactions exhibit aimless doodling by the user with an input unit of the end-user device in response to the notification; and based on said determination or exhibited aimless doodling, generating an analysis result which indicates that the positive answer from said user is false.

11. The method of claim 8,
wherein step (b4) comprises:
performing the analysis of user gestures and user interactions, and generating a determination that the user gestures and user interactions exhibit selection of a negative answer and then replacement of the negative answer with a positive answer; and based on said determination of replacement of negative answer by positive answer, generating an analysis result which indicates that the positive answer from said user is false.

12. The method of claim 8,
wherein step (b4) comprises:
performing an analysis by feeding multiple characteristics, extracted from the user gestures and user interactions, into a Machine Learning (ML) unit that is trained to classify user responses to said notification as true or false based on multiple characteristics extracted from user gestures and user interactions; and receiving from said ML unit a classification of said user responses as either (i) being classified as false or (ii) being classified as true.

13. The method of claim 8,
wherein step (b4) comprises:
generating said analysis result, which indicates that the positive answer from said user is false, based on one or more analyzed metrics that correspond at least to:
average value of typing speed, median value of typing speed, standard deviation value of typing speed.

14. The method of claim 8,
wherein step (b4) comprises:
generating said analysis result, which indicates that the positive answer from said user is false, based on one or more analyzed metrics that correspond at least to:
a ratio between (i) a cumulative time-length within a usage session in which the user is idle and does not perform any user gestures, and (ii) a cumulative time-length within said usage session in which the user is active and performs user gestures.

15. The method of claim 8,
wherein step (b4) comprises:
generating said analysis result, which indicates that the positive answer from said user is false, based on one or more analyzed metrics that correspond at least to:
a number of idle time-length period, that are exhibited by said user within a monitored time-period; wherein an idle time-length period is defined as a time-period of at least N seconds in which the user is idle and does not perform any user gestures; wherein N is a pre-defined positive number.

16. The method of claim 8,
wherein step (b4) comprises:
generating said analysis result, which indicates that the positive answer from said user is false, based on one or more analyzed metrics that correspond at least to:
a generated score of efficiency of user interactions, that is based on a ratio between (i) actual on-screen distance that an on-screen pointer has traveled among on-screen interface elements to convey user inputs, and (ii) a sum of shortest on-screen distances that can be traveled among said on-screen interface elements.

17. The method of claim 8,
wherein step (b4) comprises:
generating said analysis result, which indicates that the positive answer from said user is false, based on one or more analyzed metrics that correspond at least to:
a ratio between (i) a cumulative time-length within a usage session in which an on-screen pointer was located within active on-screen regions that are responsive to a click or a tap, and (ii) a cumulative time-length within said usage session in which the on-screen pointer was located within non-active on-screen regions that are non-responsive to clicks or taps.

18. The method of claim 8,
wherein step (b4) comprises:
generating said analysis result, which indicates that the positive answer from said user is false, based on one or more analyzed metrics that correspond at least to:
a number of occurrences of an aimless doodling activity that is exhibited by the user by aimlessly moving an on-screen pointer without performing a click or a tap.

19. The method of claim 8,
wherein step (b4) comprises:
generating said analysis result, which indicates that the positive answer from said user is false, based on one or more analyzed metrics that correspond at least to:
a frequency of occurrences of an aimless doodling activity that is exhibited by the user by aimlessly moving an on-screen pointer without performing a click or a tap.

20. The method of claim 8,
wherein step (b4) comprises:
generating said analysis result, which indicates that the positive answer from said user is false, based on one or more analyzed metrics that correspond at least to:
a number of occurrences of corrective operations performed by the user, wherein a corrective operation is a user gesture that deletes or replaces a previously-gestured input.

21. The method of claim 8,
wherein step (b4) comprises:
generating said analysis result, which indicates that the positive answer from said user is false, based on one or more analyzed metrics that correspond at least to:
a frequency of occurrences of corrective operations performed by the user, wherein a corrective operation is a user gesture that deletes or replaces a previously-gestured input.

22. The method of claim 1,
wherein the method monitors and utilizes, for said analysis, at least one of: (i) user gestures performed via a mouse, (ii) user gestures performed via a touch-pad, (iii) user gestures performed via a touch-screen.

23. The method of claim 1, further comprising:
(d) blocking or unauthorizing, at least temporarily, said online transaction that was requested via said end-user device on behalf of said corporate entity.

24. A method comprising:
(a) receiving from an end-user device a user request to perform an online banking transaction that transfers funds to a particular beneficiary; wherein the user request comprises data identifying a target bank account of said particular beneficiary;
(b) monitoring user gestures and user interactions of said user, and performing analysis of said user gestures and user interactions;
(c) based on said analysis, generating a signal indicating a determination that said user has entered said online transaction based on a fraudulent message that said user received from a third-party.

25. The method of claim 24,
wherein step (b) comprises:
(b1) generating a notification that requires the user to indicate, via his end-user device, whether or not the user performed a fresh verification with said particular beneficiary, via a non-email verification means, of the data identifying the target bank account of said particular beneficiary; and causing the end-user device of said user to convey said notification to said user;
(b2) monitoring user gestures of said user and user interactions of said user, at least from a first time-point in which said notification is conveyed to said user via his end-user device, and at least until a second-time-point in which said user conveys a positive answer to said notification via his end-user device;
(b3) receiving said positive answer from said user;
(b4) performing an analysis of user gestures and user interactions, that were monitored at least from the first time-point until the second time-point; and generating an analysis result which indicates that the positive answer from said user is false, based on one or more analyzed metrics that correspond to characteristics of the user gestures and user interactions.

26. A non-transitory storage medium having stored thereon instructions that, when executed by a processor, cause the processor to perform a method comprising:
(a) receiving from an end-user device a user request to perform an online transaction on behalf of a corporate entity;
(b) monitoring user gestures and user interactions of said user, and performing analysis of said user gestures and user interactions;
(c) based on said analysis, generating a signal indicating a determination that said user has entered said online transaction based on a fraudulent message that said user received from a third-party;
wherein step (b) comprises:
(b1) generating a notification that requires the user to indicate, via his end-user device, whether or not the user obtained managerial authorization for performing said online transaction on behalf of said corporate entity; and causing the end-user device of said user to convey said notification to said user;
(b2) monitoring user gestures of said user and user interactions of said user, at least from a first time-point in which said notification is conveyed to said user via his end-user device, and at least until a second-time-point in which said user conveys a positive answer to said notification via his end-user device;
(b3) receiving said positive answer from said user;
(b4) performing an analysis of user gestures and user interactions, that were monitored at least from the first time-point until the second time-point; and generating an analysis result which indicates that the positive answer from said user is false, based on one or more analyzed metrics that correspond to characteristics of the user gestures and user interactions.

27. A non-transitory storage medium having stored thereon instructions that, when executed by a processor, cause the processor to perform a method comprising:
(a) receiving from an end-user device a user request to perform an online banking transaction that transfers funds to a particular beneficiary; wherein the user request comprises data identifying a target bank account of said particular beneficiary;
(b) monitoring user gestures and user interactions of said user, and performing analysis of said user gestures and user interactions;
(c) based on said analysis, generating a signal indicating a determination that said user has entered said online transaction based on a fraudulent message that said user received from a third-party;
wherein step (b) comprises:
(b1) generating a notification that requires the user to indicate, via his end-user device, whether or not the user obtained managerial authorization for performing said online transaction on behalf of said corporate entity; and causing the end-user device of said user to convey said notification to said user;
(b2) monitoring user gestures of said user and user interactions of said user, at least from a first time-point in which said notification is conveyed to said user via his end-user device, and at least until a second-time-point in which said user conveys a positive answer to said notification via his end-user device;
(b3) receiving said positive answer from said user;
(b4) performing an analysis of user gestures and user interactions, that were monitored at least from the first time-point until the second time-point; and generating an analysis result which indicates that the positive answer from said user is false, based on one or more analyzed metrics that correspond to characteristics of the user gestures and user interactions.

28. A system comprising:
one or more processors to execute code,
wherein the one or more processors are operably associated with one or more memory units to store code,
wherein the one or more processors are configured to perform:
(a) receiving from an end-user device a user request to perform an online transaction on behalf of a corporate entity;
(b) monitoring user gestures and user interactions of said user, and performing analysis of said user gestures and user interactions;
(c) based on said analysis, generating a signal indicating a determination that said user has entered said online transaction based on a fraudulent message that said user received from a third-party.

29. A system comprising:
one or more processors to execute code,
wherein the one or more processors are operably associated with one or more memory units to store code,
wherein the one or more processors are configured to perform:
(a) receiving from an end-user device a user request to perform an online banking transaction that transfers funds to a particular beneficiary; wherein the user request comprises data identifying a target bank account of said particular beneficiary;
(b) monitoring user gestures and user interactions of said user, and performing analysis of said user gestures and user interactions;
(c) based on said analysis, generating a signal indicating a determination that said user has entered said online transaction based on a fraudulent message that said user received from a third-party.
